(19) United States
(12) Patent Application Publication
(10) Pub. No.: US 2006/0006985 A1
(43) Pub. Date: Jan. 12, 2006

(54) Transponder having a clock supply unit

(75) Inventor: Dirk Ziebertz, Eberstadt (DE)

Correspondence Address: BIRCH STEWART KOLASCH & BIRCH, PO BOX 747, FALLS CHURCH, VA, 22040-0747, US

(73) Assignee: ATMEL GERMANY GMBH

(21) Appl. No.: 11/172,981

(22) Filed: Jul. 5, 2005

(30) Foreign Application Priority Data
Jul. 6, 2004 (DE) DE 102004032547.2

(51) Int. Cl. H04Q 5/22

(52) U.S. Cl. 340/10.1; 340/10.34; 340/10.41

(57) ABSTRACT

A transponder is provided with a clock supply unit that includes a ring oscillator and can be used in RFID systems.

This nonprovisional application claims priority under 35 U.S.C. § 119(a) on German Patent Application No. 102004032547.2, which was filed in Germany on Jul. 6, 2004, and which is herein incorporated by reference.

### BACKGROUND OF THE INVENTION

1. Field of the Invention

The present invention relates to a transponder having a clock supply unit.

2. Description of the Background Art

Transponders are typically used in radio frequency identification (RFID) systems. Typically, data can be transmitted bidirectionally in a wireless manner between one or more base stations or readers and one or more transponders. Sensors, for example, for temperature measurement, can also be integrated in the transponder. Such transponders are also called remote sensors.

The transponders or their transmitting and receiving devices typically do not have an active transmitter for data transmission to the base station. Such inactive systems are called passive systems, when they do not have their own power supply, and semipassive systems, when they have their own power supply. Passive transponders draw the energy necessary for their supply from the electromagnetic field emitted by the base station.

For data transmission from a transponder to a base station with UHF or microwaves in the far field of the base station, as a rule, so-called backscatter coupling is employed. To that end, the base station emits electromagnetic carrier waves, which are modulated and reflected by the sending and receiving device of the transponder by a modulation process in accordance with the data to be transmitted to the base station. The typical modulation methods for this are amplitude modulation, phase modulation, and amplitude shift keying (ASK) subcarrier modulation, in which the frequency or the phase position of the subcarrier is modified.

The transponders usually have a clock supply unit, which can be used, inter alia, for evaluating or decoding received signals. If the transmitted data were encoded, for example, with use of pulse width modulation, then the pulse duration can be measured by the clock supply unit. The clock supply unit is used hereby, for example, for clocking a digital counter whose counter reading then corresponds to an appropriate pulse duration.

Conventional clock supply units are usually configured as oscillators, for example, as RC oscillators. In the normal case, the clock supply unit is free running; i.e., it is not synchronized with a transmitting unit of the base station. This can lead to so-called jitter effects in the evaluation of the received signal in the transponder. Because synchronization presumes a start, as undelayed as possible, of the clock supply, synchronization during use of conventional clock supply units is usually difficult or not possible, because the oscillators require a certain transient period or start time.

### SUMMARY OF THE INVENTION

It is therefore an object of the present invention to provide a transponder having a clock supply unit, and which has a low transient period.

As taught by the invention, the clock supply unit comprises a ring oscillator. A ring oscillator can include a closed chain of inverters connected in series. There are an odd number of inverters. The output of the last inverter is again connected to the input of the first inverter. A square-wave oscillator arises in this way whose oscillation frequency is determined by the delay time of the specific inverters. The use of a ring oscillator as a clock source enables a virtually undelayed turning on or off of the clock source by interrupting or closing of the inverter chain, because each inverter in the chain always assumes a stable state. A transient does not occur as, for example, in an RC oscillator. This makes possible synchronization of the clock source with an external clock source, for example, a base station, as a result of which jitter effects can be largely avoided.

In a further embodiment of the invention, the ring oscillator is constructed using source-coupled logic (SCL) technology. Because of the employed differential signal transmission, the insensitivity to common mode interferences, for example, to dynamic supply voltage variations, improves. As a result, operations proceed with lower signal voltage swings, as a result of which the current consumption is reduced in comparison with systems operating with a full supply voltage swing. This in turn improves the transmission range, particularly in passive transponders.

In yet a further embodiment, the transponder comprises a frequency control unit, which, depending on a clock frequency to be set, can set an operating parameter of the ring oscillator. This makes it possible to match the frequency of the clock supply unit within certain limits to the prevailing environmental conditions. In conventional clock supply units, this is possible only with a considerable circuit engineering effort. The operating parameter can be a bias voltage of a source-coupled logic module. A change in the bias voltage can change the delay time of the inverter(s) and thereby the oscillation frequency or the clock frequency of the ring oscillator.

In another embodiment, the ring oscillator comprises at least one inverter, which is configured as a NAND gate or as a NOR gate. The NAND or NOR gate(s) can be wired as inverters. This makes it possible to use standard gates and thereby reduces the manufacturing costs.

Also, the ring oscillator can include an activation element for its activation and deactivation. This makes possible, for example, the deactivation of the clock supply for time intervals during which no clock supply is necessary. The current consumption of the transponder declines accordingly. The activation element can be a NAND gate. This in turn can be realized simply with use of standard cells.

The transponder can also include a synchronization unit, which is coupled to the activation unit. The synchronization unit can generate a synchronization signal, for example, to synchronize the clock supply unit with an external clock signal, for example, that is generated by the base station. The activation unit then activates the clock supply as a function of the synchronization signal. Because of the virtually delay-free start of the ring oscillator, jitter effects are thereby largely avoided.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a block diagram of a transponder with a clock supply unit;

FIG. 2 is a block diagram of a ring oscillator shown in FIG. 1; and

FIG. 3 is a schematic circuit diagram of the internal structure of an inverter shown in FIG. 2 using SCL technology.

### DETAILED DESCRIPTION

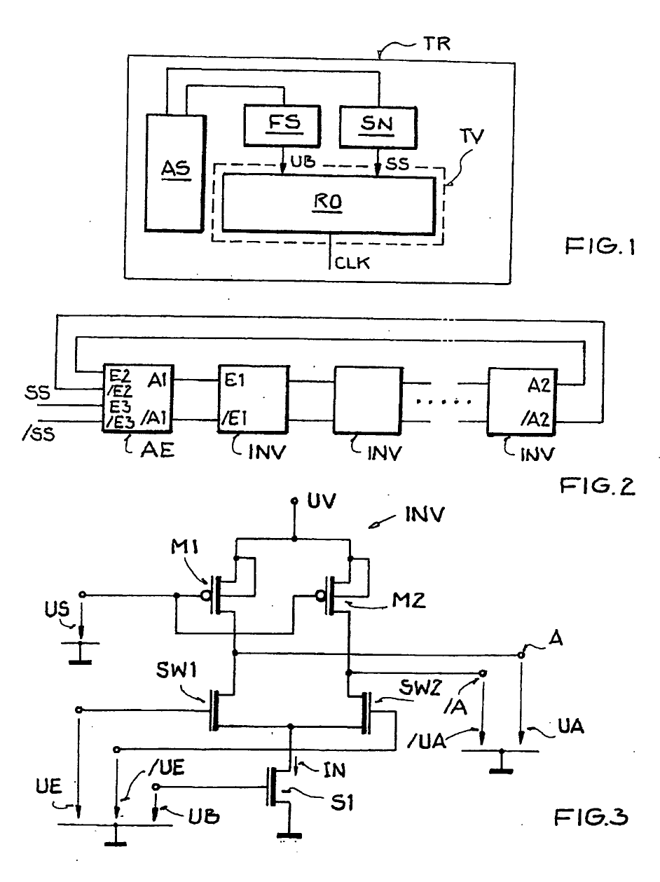

FIG. 1 shows a block diagram of a passive transponder TR, which comprises, apart from other modules which are not shown, a clock supply unit TV, a frequency control unit FS, a synchronization unit SN, and a sequence control unit AS.

The clock supply unit TV generates a clock signal CLK and comprises a ring oscillator RO, which can use SCL technology. The clock signal CLK is used, inter alia, for coding and decoding of messages. The internal structure of the ring oscillator is illustrated in detail in FIG. 2.

The sequence control unit AS is used to control the frequency control unit FS and the synchronization unit SN. The sequence control unit AS generates the appropriate control signals for the frequency control unit FS and the synchronization unit SN as a function of the operating state of the transponder TR and its programming. The sequence control unit AS can be implemented, for example, as a state machine.

The frequency control unit FS is coupled to the clock supply unit TV and, as a function of a clock frequency to be set, which is preset by the sequence control AS, sets a bias voltage UB of gates, configured using SCL technology, of the ring oscillator RO. The bias voltage UB determines the specific gate delay and thereby the intrinsic or natural frequency of the ring oscillator RO. This makes possible a frequency matching to specific environmental boundary conditions.

The synchronization unit SN is also coupled to the clock supply unit TV and generates a synchronization signal SS, which is used to activate or deactivate the ring oscillator RO. This makes possible synchronization with external clock sources, for example, during receipt of messages from a base station (not shown) by the transponder TR, as a result of which jitter effects can be largely eliminated. Furthermore, the ring oscillator can be deactivated during phases in which no communication occurs.

FIG. 2 shows a block diagram of the internal structure of the ring oscillator RO shown in FIG. 1. The ring oscillator RO comprises an even number n, for example, 20, of inverters INV, which are realized using SCL technology, and an activation element AE in the form of a NAND gate, which in the activated state acts as another inverter within the inverter chain, which produces an uneven number n+1 of inverters overall. The inverters INV can be configured as dedicated inverter cells, as conventional NAND gates, and/or as NOR gates, which are wired in each case as inverters.

The inputs or outputs of the gates shown in FIG. 2 are configured as differential inputs or outputs according to the employed SCL technology, i.e., as input or output pairs.

The inverters INV and the activation element AE are connected in series, whereby an output pair A1 and /A1 of the activation element AE is connected to an input pair E1 and /E1 of a first inverter INV in the inverter chain; next an output pair each of a preceding inverter INV is connected to an input pair each of a subsequent inverter INV, and an output pair A2 and /A2 of a last inverter INV of the inverter chain is connected to an input pair E2 and /E2 of the activation element AE configured as a NAND gate.

An input pair E3 and /E3 of the activation element AE is coupled to the synchronization unit SN of FIG. 1. The synchronization unit SN supplies the input pair E2 and /E2 with the differential synchronization signals SS and /SS, whereby in FIG. 1 for reasons of a better overview only the signal SS is shown. When a logic “1” occurs at the input pair E3 and /E3, the ring oscillator is activated; i.e., the activation element acts as another inverter only within the inverter chain. When a logic “0” occurs at the input pair E3 and /E3, a logic “1” occurs statically at the output of the activation element AE; i.e., oscillation of the ring oscillator is prevented. The inverters INV of the inverter chain thereupon all assume a defined state, as a result of which an immediate starting of oscillations is assured after a new activation.

FIG. 3 shows a schematic circuit diagram of the internal structure an inverter INV using SCL technology, as shown in FIG. 2. The inverter comprises PMOS transistors M1 and M2, which act as so-called active loads. Via a control voltage US applied at the specific gate electrodes, a signal voltage swing UH can be influenced by output voltages UA and /UA at outputs A and /A of the inverter INV. Because of the differential representation or transmission of the output signals of the inverter INV and the resulting insensitivity to common mode interferences, the control voltage US can be selected so that a lower signal voltage swing UH results. This leads to a reduced current consumption by the inverter INV. The signal voltage swing UH can constitute, for example, a tenth of a supply voltage UV of the inverter INV.

The inverter INV comprises furthermore NMOS transistors SW1 and SW2, which function as switches. The switching state of the transistors SW1 and SW2 is determined by the state of the input signals UE or /UE, respectively. Depending on its switching state, either the supply voltage UV or a voltage UV-UH is applied at the outputs A or /A.

Another NMOS transistor S1 is used to set the gate delay of the inverter INV. The gate delay is determined by the bias voltage UB, which is applied at a gate electrode of the transistor S1. The bias voltage UB controls a cross current IN across transistor S1 and consequently determines, apart from the control voltage US, the current consumption of the inverter INV.

The structure shown for an inverter INV can also be applied to the activation unit AE configured as NAND gates using SCL technology, whose gate delay is also controlled by the voltage UB.

In the shown exemplary embodiment, the frequency control unit FS sets only the bias voltage UB, which determines the gate delay of the inverter INV and the activation unit AE. The frequency control unit FS, of course, can also set the control voltage US, which is often also called the bias voltage in relation to SCL technology.

The clock supply unit TV of the transponder TR, as shown in the exemplary embodiment, can be activated and deactivated free of delay and thus enables synchronization of the clock supply with external clock sources. This effectively prevents the occurrence of jitter problems, for example, during receipt of data from the base station. Furthermore, the frequency can be easily set and the current consumption is low.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A transponder having a clock supply unit, the clock supply unit including a ring oscillator.

2. The transponder according to claim 1, wherein the ring oscillator is has source-coupled logic technology.

3. The transponder according to claim 1, wherein the transponder further comprises a frequency control unit, which, depending on a clock frequency to be set, sets an operating parameter of the ring oscillator.

4. The transponder according to claim 3, wherein the operating parameter is a bias voltage of a source-coupled logic module.

5. The transponder according to claim 1, wherein the ring oscillator comprises at least one inverter which is configured as a NAND gate or NOR gate.

6. The transponder according to claim 1, wherein the ring oscillator comprises an activation element for activating and deactivating the ring oscillator.

7. The transponder according to claim 6, wherein the activation element is a NAND gate.

8. The transponder according to claim 6, wherein a synchronization unit is coupled to the activation unit.

9. The transponder according to claim 1, wherein the transponder is a passive or semipassive transponder.
